(19) United States
(12) Patent Application Publication
(10) Pub. No.: US 2006/0013004 A1
(43) Pub. Date: Jan. 19, 2006

(54) LED sideward emitting lamp

(76) Inventors: Charles Coushaine, Rindge, NH (US); Michael Tucker, Henniker, NH (US); Thomas Tessnow, Weare, NH (US); Fred Peterson, Sanbornton, NH (US)

Correspondence Address: William E. Meyer;OSRAM SYLVANIA Inc., 100 Endicott Street, Danvers, MA, 01923, US

(21) Appl. No.: 11/121,493

(22) Filed: May 3, 2005

Related U.S. Application Data
(60) Provisional application No. 60/588,143, filed on Jul. 16, 2004.

(51) Int. Cl. F21V 7/00

(52) U.S. Cl. 362/347

(57) ABSTRACT

A lamp (10) has a reflector (12) arrayed about an axis (14). The reflector has a circumferential rim (16) and an LED light source (18) that is mounted upon a support (20). The support can be arrayed along the circumferential rim (16) or mounted directly to the concave reflector (12).

### CROSS-REFERENCE TO RELATED APPLICATION

This application claims priority from Provisional Patent Application Serial No. 60/588,143, filed Jul. 16, 2004.

### TECHNICAL FIELD

This invention relates to light sources and more particularly to light sources employing light emitting diodes (LED or LEDs) and more particularly to light sources useful in the automotive field such as for headlights, taillights, stoplights, fog lights, turn signals, etc.

### BACKGROUND ART

In the past, most automotive light sources have involved the use of incandescent bulbs. While working well and being inexpensive, these bulbs have a relatively short life and, of course, the thin filament employed was always subject to breakage due to vibration.

Recently some of the uses have been replaced by LEDs. These solid-state light sources have incredible life times, in the area of 100,000 hours, and are not as subject to vibration failures. Particular examples of various proposals are shown in U.S. Pat. Nos. 6,641,287; 5,136,483; 6,474,852; 6,672,741; 6,238,073; 5,471,371; 6,840,652; and 6,585,402. While providing workable strategies, the lamps are complex and expensive to produce and require difficult LED mounting structures or alignment procedures. It would be an advance in the art if LED illumination could be expanded to other areas of automotive lighting, particularly if the emission of the light could be adequately controlled for specific purposes and if the mounting procedures were simple, relatively inexpensive, and easy to employ.

### DISCLOSURE OF INVENTION

It is, therefore, an object of the invention to obviate the disadvantages of the prior art.

It is another object of the invention to enhance LED light sources.

It is another object of the invention to enhance LED and reflector combinations.

These objects are accomplished, in one aspect of the invention; by the provision of a lamp comprising a concave reflector arrayed about an axis and having a circumferential rim; and an LED light source mounted upon a support that is associated with said concave reflector, said support being arrayed along said circumferential rim and directing light toward said concave reflector.

In an alternative embodiment there is provided a lamp comprising a concave reflector arrayed about an axis and having a circumferential rim and an LED light source mounted upon a support that is associated with said concave reflector, said support having an end that is fixed in said concave reflector.

Such lamps provide relative simplicity in construction with ease of alignment.

### BRIEF DESCRIPTION OF THE DRAWINGS

FIG. 1 is a diagrammatic view of an embodiment of the invention;

FIG. 2 is a diagrammatic view of an alternate embodiment of the invention;

FIG. 3 is a diagrammatic view of yet another embodiment of the invention; and

FIG. 4 is a diagrammatic view of still another embodiment of the invention.

### BEST MODE FOR CARRYING OUT THE INVENTION

For a better understanding of the present invention, together with other and further objects, advantages and capabilities thereof, reference is made to the following disclosure and appended claims taken in conjunction with the above-described drawings.

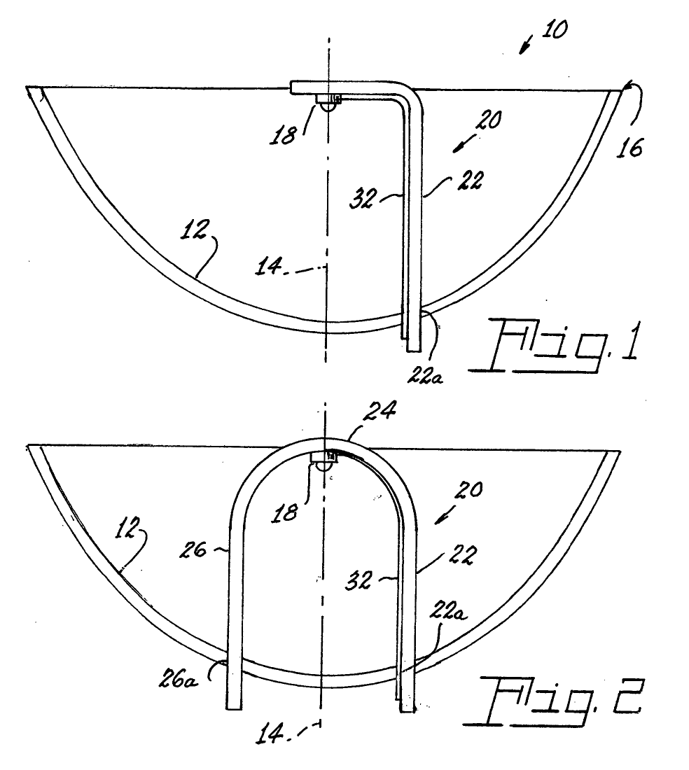

Referring now to the drawings with greater particularity, there is shown in FIG. 1 a lamp 10 that comprises a concave reflector 12 arrayed about an axis 14 and having a circumferential rim 16. An LED light source 18 is mounted upon a support 20 that is associated with the concave reflector 12, the support 20 having a leg 22 that is fixed in the concave reflector 12, for example by a press-fit of the leg 22 in a slot 22a. The LED light source 18 can be of any suitable style, such as a side emitting LED and the emitted color can be suitable for the lamp's purpose, for example, red emitting for a tail light or stop light or white for a headlight. More than one LED can be employed if desired. If only one LED is used it is preferably aligned along the axis 14.

An alternate embodiment is shown in FIG. 2 wherein the support 20 is U-shaped with a bight 24 and legs 22, 26. The LED light source 18 is mounted in the bight 24 of the U-shaped support in a manner to direct light directly toward the concave reflector 12 and the legs 22, 26 of the U-shaped support are fixed in said concave reflector 12 in any suitable manner, for example by being press-fitted into slots 22a and 26a.

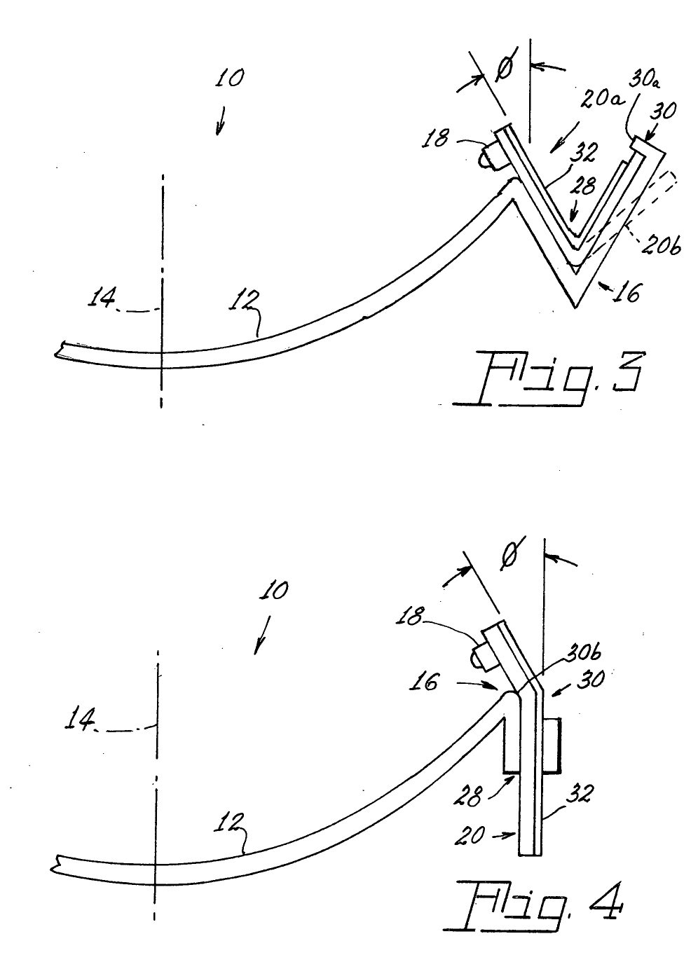

In FIG. 3 the lamp 10 similarly comprises a concave reflector 12 arrayed about an axis 14 and having a circumferential rim 16. However, in this instance an LED light source 18 is mounted upon a support 20a that is V-shaped and associated with the concave reflector 12 by being arrayed along the circumferential rim with the LED light source 18 directing light toward the concave reflector from the edge instead of from the center.

The circumferential rim 16 has a mounting groove 28 that can be in the form of a V-shaped trough as shown in FIG. 3 or as a series of openings, only one of which is shown, in FIG. 4. The V-shaped trough can be continuous circumferentially or be formed as one or more discrete areas, depending upon the number of LEDs to be used. The groove 28 is provided with a support retainer 30 that can be in the form of an extending lip 30a as shown in FIG. 3. In this case the V-shaped support 20a can have an original configuration 20b and can be compressed to snap-fit into the housing. Alternatively, an angled surface 30b as shown in FIG. 4 can be provided.

The support 20 is thermally conductive to remove operational heat from the LED or LEDs and is also provided with the circuitry 32 (shown diagrammatically) necessary to operate the lamp in its chosen environment.

When mounted on or near the rim 16 the LED light source 18 is mounted at an angle θ relative to the axis 14 to insure proper alignment. While the angle will, of course, be dependent upon the curvature of the reflector and the particular LED being used, with a parabolic reflector typical of those used for automotive functions, an angle of approximately 30 degrees will provide good results for directing light from the LED 18 onto the surface of the reflector 12.

As a result the LEDs 18 are widely spread around the reflector rim providing improved heat dispersion while concentrating the emitted light on the reflector.

No holes are formed in the center of the reflector so no shadows or gaps are created in the resulting beam pattern. The snap fit assembly assures proper positioning of the LEDs

While there have been shown and described what are present considered to be the preferred embodiments of the invention, it will be apparent to those skilled in the art that various changes and modifications can be made herein without departing from the scope of the invention as defined by the appended claims.

What is claimed is:

1. A lamp comprising:
a concave reflector arrayed about an axis and having a circumferential rim;
an LED light source mounted upon a support that is associated with said concave reflector, said support being arrayed along said circumferential rim and directing light toward said concave reflector.

2. A lamp comprising:
a concave reflector arrayed about an axis and having a circumferential rim;
an LED light source mounted upon a support that is associated with said concave reflector, said support having an end that is fixed in said concave reflector.

3. The lamp of claim 2 wherein said support is U-shaped, said LED light source is mounted in the bight of said U-shaped support in a manner to direct light directly toward said concave reflector and the legs of said U-shaped support are fixed in said concave reflector.

4. The lamp of claim 1 wherein said circumferential rim includes a mounting groove that has a support retainer.

5. The lamp of claim 4 wherein said support is engaged with said mounting groove and said support retainer.

6. The lamp of claim 1 wherein said support includes thermally conductive material to carry away and excess heat generated by said LED light source when said LED light source is operating.

7. The lamp of claim 6 wherein said support includes electrical circuitry for operating said LED light source.

8. The lamp of claim 2 wherein said support includes thermally conductive material to carry away and excess heat generated by said LED light source when said LED light source is operating.

9. The lamp of claim 3 wherein said support includes thermally conductive material to carry away any excess heat generated by said LED light source when said LED light source is operating.

10. The lamp of claim 1 wherein said support includes electrical circuitry for operating said LED light source.

11. The lamp of claim 1 wherein said support is maintained with said rim by a tensioned force.

12. The lamp of claim 1 wherein said reflector has a center portion located about said axis and said center portion is aperture-free.

13. The lamp of claim 2 wherein said reflector has a center portion located about said axis and said center portion is aperture-free.
